(19) United States
(12) Patent Application Publication
(10) Pub. No.: US 2025/0093173 A1
(43) Pub. Date: Mar. 20, 2025

(54) GOAL-ORIENTED DIRECTIONS

(71) Applicant: GOOGLE LLC, Mountain View, CA (US)

(72) Inventors: Matthew Sharifi, Mountain View, CA (US); Jyrki Alakuijala, Mountain View, CA (US)

(21) Appl. No.: 18/559,638

(22) PCT Filed: Jan. 4, 2023
(86) PCT No.: PCT/US2023/010093

§ 371 Date: Nov. 8, 2023

(51) Int. Cl. G01C 21/36; G01C 21/34

(52) U.S. Cl. CPC G01C 21/3644; G01C 21/343

(57) ABSTRACT

To provide navigation directions to one or more points of interest (POIs) for accomplishing a user's goals, a computing device receives an indication of N goals for a user to accomplish, and identifies M POIs for accomplishing the N goals. N is greater than M. The computing device then generates a set of navigation directions for navigating to each of the M POIs, and provides the set of navigation directions for display to the user.

### FIELD OF THE DISCLOSURE

The present disclosure generally relates to determining destinations for a user to accomplish a set of tasks or goals and providing navigation directions to each of the determined destinations.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, many users request map and navigation data for various geographic locations. Software applications executing in computers, smartphones, embedded devices, etc., generate step-by-step navigation directions in response to receiving input from a user, specifying the starting point and the destination. The navigation directions are typically generated for a route which guides the user to the destination in the shortest amount of time.

### SUMMARY

In some scenarios, a user may not have a specific destination in mind, but instead may have a set of tasks or goals that they wish to accomplish. For example, the user may have a shopping list of items that they need to purchase. The user may want to work out, and then pick up a sandwich for dinner. To provide the user with directions to points of interest (POIs) for accomplishing each of their goals, a goal-oriented navigation system identifies a POI where the user can accomplish each goal. In some scenarios, the goal-oriented navigation system may identify the same POI for accomplishing multiple goals. For example, the user may provide a set of N goals (e.g., where N is greater than one) and the goal-oriented navigation system may identify M POIs (e.g., where M is at least one) for accomplishing the N goals, where M is less than N. More specifically, if the user's goals include a set of N items to purchase, the goal-oriented navigation system may identify a single POI where the user can purchase each of the N items. In another example, the goal-oriented navigation system may identify a first POI where the user can purchase N−1 items and a second POI where the user can purchase the remaining item.

The goal-oriented navigation system may select POIs for accomplishing each of the goals which minimize the total number of POIs selected, the distance from the user's current location to the POIs, and/or the distance between each of the POIs. For example, for each goal, the goal-oriented navigation system may identify a set of candidate POIs for accomplishing the goal. Then the goal-oriented navigation system may select one of the candidate POIs which minimizes the total number of POIs selected, the distance from the user's current location to the selected POI, and/or the distance between the selected POIs and the other POIs for accomplishing the other goals. More specifically, when the set of candidate POIs for accomplishing a second goal includes a candidate POI which has already been selected for accomplishing a first goal, the goal-oriented navigation system may select the candidate POI to accomplish the second goal, so that the same POI is selected for both the first and second goals. This minimizes the total number of POIs selected, and the distance between the POIs for the first and second goals is zero. As such, an efficient route is provided that both accomplishes the goals and minimizes the number of different locations visited.

The goal-oriented navigation system may generate a set of navigation directions for navigating to each of the selected POIs along a route that minimizes distance or duration. In some implementations, the goal-oriented navigation system also determines the order for navigating to each of the selected POIs. For example, the goal-oriented navigation system may determine an order which minimizes the total duration or distance of the route to each of the POIs. The goal-oriented navigation system may generate a first route for navigating to each of the POIs in a first order, a second route for navigating to each of the POIs in a second order, an nth route for navigating to each of the POIs in an nth order, etc. Then the goal-oriented navigation system may identify the route of the generated routes with the shortest distance or duration.

In other implementations, the user may specify the order for accomplishing at least some of the goals. For example, the user may indicate that they want to go to the gym first before purchasing the items on their shopping list. The goal-oriented navigation system may then generate a route for navigating to each of the POIs in the order indicated by the user. Beneficially, the user may therefore specify certain customization of the route in order to visit a preferred POI at a certain point (e.g., first or last). This balances the need for customization with route efficiency, providing a flexible and efficient route which accomplishes all goals. In yet other implementations, the goal-oriented system may take other factors into account when determining the order for navigating to each of the selected POIs, such as the store hours for the POIs, whether a corresponding goal can be accomplished at night or during the day, whether an activity has a fixed time window (e.g., eating lunch), etc. Then the goal-oriented system may determine an order so that the user arrives at each of the POIs during store hours, and/or at the appropriate time for accomplishing the goal.

The goal-oriented navigation system may then provide a set of navigation directions for display to the user, via a navigation application, for traveling along the selected route to each of the selected POIs in the selected order. In some implementations, the goal-oriented navigation system may present indications of each of the selected POIs on a map display of the navigation application. The goal-oriented navigation system may also annotate each selected POI on the map display with a description of the corresponding goal(s) to accomplish at the selected POI. Additionally or alternatively, when the user arrives at one of the selected POIs, the navigation application may present an indication on the map display of the goal(s) to accomplish at the POI, and/or may present an audio announcement to the user indicating the goal(s) to accomplish at the POI. By specifying which goal is to be completed at each POI, the user is provided with a clear indication of what to do at each POI. This is particularly beneficial is the scenario in which it would be assumed that multiple goals are to be completed at a POI, when it fact a different one or more goals should be completed. For example, the user may assume that products A and B should be purchased at a first POI, when in fact the first POI only stocks product A and product B is to be purchased at a second POI.

In this manner, the goal-oriented navigation system allows the user to provide a set of goals that they want to accomplish without having to identify specific POIs for accomplishing these goals. The goal-oriented navigation system also minimizes the number of POIs necessary to accomplish the user's goals, and optimizes the route and order of traveling to the POIs so that the user can accomplish all of their goals in the shortest amount of time or by traveling the shortest distance.

This also improves the user experience by reducing the amount of operations a user has to perform to receive navigation directions for accomplishing a set of goals. Typically, a user would have to perform additional research for example, via a search engine to identify stores or other places for accomplishing the user's goals. The present embodiments advantageously do not require the user to perform this additional research and execute search engine queries. Instead, the user may simply provide their goal-based input to the goal-oriented navigation system which identifies POIs for accomplishing the user's goals and provides navigation directions to the identified POIs.

One example embodiment of the techniques of this disclosure is a method for providing navigation directions to one or more points of interest (POIs) for accomplishing a user's goals. The method includes receiving an indication of N goals for a user to accomplish, and identifying M POIs for accomplishing the N goals, where N is greater than M. The method also includes generating a set of navigation directions for navigating to each of the M POIs, and providing the set of navigation directions for display to the user.

Another example embodiment is a computing device for providing navigation directions to one or more points of interest (POIs) for accomplishing a user's goals. The computing device includes one or more processors and a computer-readable memory, which is optionally non-transitory, coupled to the one or more processors and storing instructions thereon. The instructions, when executed by the one or more processors, cause the computing device to receive an indication of N goals for a user to accomplish, and identify M POIs for accomplishing the N goals, where N is greater than M. The instructions further cause the computing device to generate a set of navigation directions for navigating to each of the M POIs, and provide the set of navigation directions for display to the user.

Yet another example embodiment is a computer-readable medium, which is optionally non-transitory, storing instructions, that when executed by one or more processors cause the one or more processors to receive an indication of N goals for a user to accomplish, and identify M POIs for accomplishing the N goals, where N is greater than M. The instructions further cause the one or more processors to generate a set of navigation directions for navigating to each of the M POIs, and provide the set of navigation directions for display to the user.

### BRIEF DESCRIPTION OF THE DRAWINGS

FIG. 1 is a block diagram of an example communication system in which techniques for providing navigation directions to one or more POIs for accomplishing a user's goals can be implemented;

FIG. 2 illustrates an example request from a user to the user computing device of FIG. 1 including a set of tasks or goals for the user;

FIG. 3 illustrates an example map display including the request indicated in FIG. 2, destinations or POIs responsive to the request, and an example route for traveling to the POIs;

FIG. 4 illustrates another example map display as the user approaches a POI for accomplishing some of the goals;

FIG. 5 illustrates another example request from a user to the user computing device of FIG. 1, and an example response to the request indicating a corresponding POI for each of the items on the user's shopping list and beginning route guidance to the POIs; and

FIG. 6 is a flow diagram of an example method for providing navigation directions to one or more POIs for accomplishing a user's goals, which can be implemented in a computing device, such as the server device of FIG. 1.

### DETAILED DESCRIPTION

### Overview

Generally speaking, the techniques of this disclosure include a user computing device, a vehicle computing device, and/or one or more network servers. However, for clarity, the examples below focus primarily on an embodiment in which a user computing device obtains a set of tasks or goals from the user for providing navigation directions to POIs corresponding to the set of tasks or goals. For example, the goals may include a shopping list for the user to complete, products for the user to purchase, meals for the user to eat, activities for the user to perform, etc. In some scenarios, a goal may have a specific destination, such as when the user requests to work out at a specific gym. In other instances, the goal may not have a specific destination, such as when the user requests to eat lunch but does not specify where the user would like to eat lunch or the type of food. Also in some instances, goals may have time or ordering preferences. For example, the user may want to work out before they eat. In other instances, the goals may not have time preferences and can be accomplished in any order.

In any event, the user computing device provides the set of tasks or goals to a server device. For example, the set may include N goals where N is greater than one. Then for each goal, the server device identifies a set of candidate POIs where the goal can be accomplished. The server device then selects one of the POIs in each set to minimize the total number of POIs selected, and/or the distance or duration that the user has to travel from their current location to reach each of the selected POIs. For example, when multiple sets of candidate POIs include the same POI, the server device may select that POI so that the user can accomplish multiple goals at the same place. In any event, the server device selects M POIs for accomplishing the N goals, where M is at least one. In some instances, such as when multiple goals can be accomplished at the same place, M is less than N.

Then the server device obtains navigation directions from the user's current location or another starting location specified by the user to each of the M POIs, for example from a navigation server or map database. The map database may provide the navigation directions which minimize the distance or duration for traveling to the M POIs. Additionally, in some implementations, the server device may select the order for navigating to the POIs. For example, the map database may provide sets of navigation directions for each ordered combination of the M POIs with estimated distances or durations for navigating to each of the M POIs. The server device may then select the order which minimizes the distance or duration of the trip.

The server device then provides the set of navigation directions to each of the M POIs to the user computing device for display on a map display of the user computing device. Additionally, the server device may provide indications of which goals correspond to which POIs. Then for each POI, the user computing device may display an indication of the goal(s) to accomplish at the POI on the map display. When the user approaches a particular POI, the user computing device may provide an audio announcement or text on the map display indicating the goal(s) to accomplish at the particular POI.

### Example Hardware and Software Components

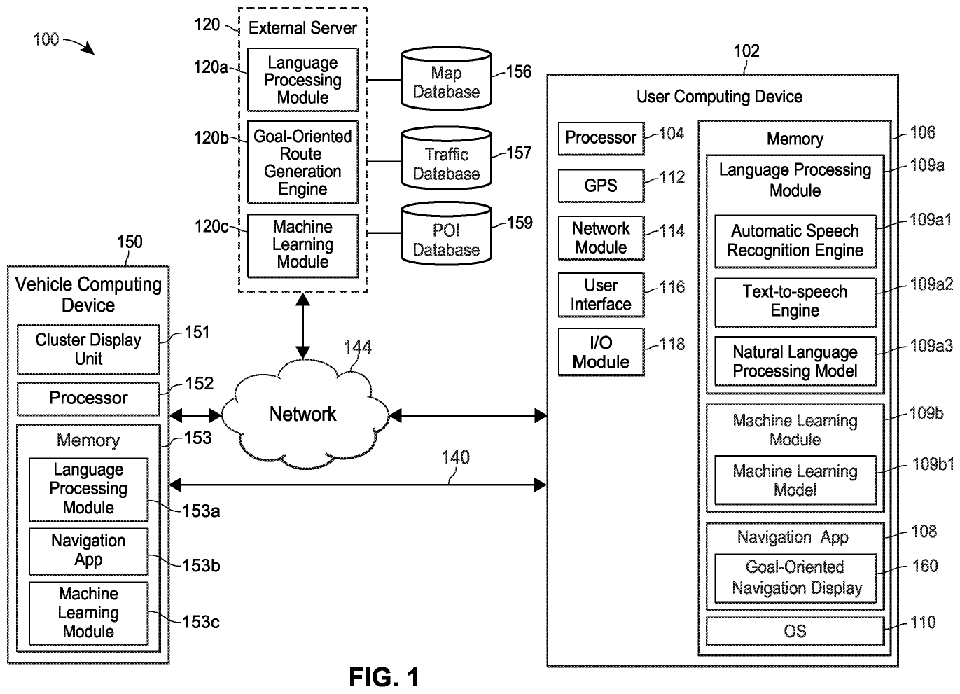

Referring first to FIG. 1, an example communication system 100 in which techniques for goal/task-oriented navigation can be implemented includes a user computing device 102. The user computing device 102 may be a portable device such as a smart phone or a tablet computer, for example. The user computing device 102 may also be a laptop computer, a desktop computer, a personal digital assistant (PDA), a wearable device such as a smart watch or smart glasses, etc. In some embodiments, the user computing device 102 may be removably mounted in a vehicle, embedded into a vehicle, and/or may be capable of interacting with a head unit of a vehicle to provide navigation instructions. In other embodiments, the user computing device 102 is not within a vehicle environment.

The user computing device 102 may include one or more processor(s) 104 and a memory 106 storing machine-readable instructions executable on the processor(s) 104. The processor(s) 104 may include one or more general-purpose processors (e.g., CPUs), and/or special-purpose processing units (e.g., graphical processing units (GPUs)). The memory 106 can be, optionally, a non-transitory memory and can include one or several suitable memory modules, such as random access memory (RAM), read-only memory (ROM), flash memory, other types of persistent memory, etc. The memory 106 may store instructions for implementing a navigation application 108 that can provide navigation directions (e.g., by displaying directions or emitting audio instructions via the user computing device 102), display an interactive digital map, request and receive routing data to provide driving, walking, or other navigation directions, provide various geo-located content such as traffic, points-of-interest (POIs), and weather information, etc.

Further, the memory 106 may include a language processing module 109a configured to implement and/or support the techniques of this disclosure for determining places and routes through natural conversation. Namely, the language processing module 109a may include an automatic speech recognition (ASR) engine 109a1 that is configured to transcribe speech inputs from a user into sets of text. Further, the language processing module 109a may include a text-to-speech (TTS) engine 109a2 that is configured to convert text into audio outputs, such as audio requests, navigation instructions, and/or other outputs for the user. In some scenarios, the language processing module 109a may include a natural language processing (NLP) model 109a3 that is configured to output textual transcriptions, intent interpretations, and/or audio outputs related to a speech input received from a user of the user computing device 102. It should be understood that, as described herein, the ASR engine 109a1 and/or the TTS engine 109a2 may be included as part of the NLP model 109a3 in order to transcribe user speech inputs into a set of text, convert text outputs into audio outputs, and/or any other suitable function described herein as part of a conversation between the user computing device 102 and the user.

Generally, the language processing module 109a may include computer-executable instructions for training and operating the NLP model 109a3. In general, the language processing module 109a may train one or more NLP models 109a3 by establishing a network architecture, or topology, and adding layers that may be associated with one or more activation functions (e.g., a rectified linear unit, softmax, etc.), loss functions and/or optimization functions. Such training may generally be performed using a symbolic method, machine learning (ML) models, and/or any other suitable training method. More generally, the language processing module 109a may train the NLP models 109a3 to perform two techniques that enable the user computing device 102, and/or any other suitable device (e.g., vehicle computing device 151) to understand the words spoken by a user and/or words generated by a text-to-speech program (e.g., TTS engine 109a2) executed by the processor 104: syntactic analysis and semantic analysis.

Syntactic analysis generally involves analyzing text using basic grammar rules to identify overall sentence structure, how specific words within sentences are organized, and how the words within sentences are related to one another. Syntactic analysis may include one or more sub-tasks, such as tokenization, part of speech (POS) tagging, parsing, lemmatization and stemming, stop-word removal, and/or any other suitable sub-task or combinations thereof. For example, using syntactic analysis, the NLP model 109a3 may generate textual transcriptions from the speech inputs from the user. Additionally, or alternatively, the NLP model 109a3 may receive such textual transcriptions as a set of text from the ASR engine 109al in order to perform semantic analysis on the set of text.

Semantic analysis generally involves analyzing text in order to understand and/or otherwise capture the meaning of the text. In particular, the NLP model 109a3 applying semantic analysis may study the meaning of each individual word contained in a textual transcription in a process known as lexical semantics. Using these individual meanings, the NLP model 109a3 may then examine various combinations of words included in the sentences of the textual transcription to determine one or more contextual meanings of the words. Semantic analysis may include one or more sub-tasks, such as word sense disambiguation, relationship extraction, sentiment analysis, and/or any other suitable sub-tasks or combinations thereof. For example, using semantic analysis, the NLP model 109a3 may generate one or more intent interpretations based on the textual transcriptions from the syntactic analysis.

In these aspects, the language processing module 109a may include an artificial intelligence (AI) trained conversational algorithm (e.g., the natural language processing (NLP) model 109a3) that is configured to interact with a user that is accessing the navigation application 108. The user may be directly connected to the navigation application 108 to provide verbal input/responses (e.g., speech inputs), and/or the user request may include textual inputs/responses that the TTS engine 109a2 (and/or other suitable engine/model/algorithm) may convert to audio inputs/responses for the NLP model 109a3 to interpret. When a user accesses the navigation application 108, the inputs/responses spoken by the user and/or generated by the TTS engine 109a2 (or other suitable algorithm) may be analyzed by the NLP model 109a3 to generate textual transcriptions and intent interpretations.

The language processing module 109a may train the one or more NLP models 109a3 to apply these and/or other NLP techniques using a plurality of training speech inputs from a plurality of users. As a result, the NLP model 109a3 may be configured to output textual transcriptions and intent interpretations corresponding to the textual transcriptions based on the syntactic analysis and semantic analysis of the user's speech inputs.

In certain aspects, one or more types of machine learning (ML) may be employed by the language processing module 109a to train the NLP model(s) 109a3. The ML may be employed by the ML module 109b, which may store a ML model 109b1. The ML model 109b1 may be configured to receive a set of text corresponding to a user input, and to output an intent and set of goals based on the set of text. The NLP model(s) 109a3 may be and/or include one or more types of ML models, such as the ML model 109b1. More specifically, in these aspects, the NLP model 109a3 may be or include a machine learning model (e.g., a large language model (LLM)) trained by the ML module 109b using one or more training data sets of text in order to output one or more training intents and one or more training destinations, as described further herein. For example, artificial neural networks, recurrent neural networks, deep learning neural networks, a Bayesian model, and/or any other suitable ML model 109b1 may be used to train and/or otherwise implement the NLP model(s) 109a3. In these aspects, training may be performed by iteratively training the NLP model(s) 109a3 using labeled training samples (e.g., training user inputs).

In instances where the NLP model(s) 109a3 is an artificial neural network, training of the NLP model(s) 109a3 may produce byproduct weights, or parameters which may be initialized to random values. The weights may be modified as the network is iteratively trained, by using one of several gradient descent algorithms, to reduce loss and to cause the values output by the network to converge to expected, or “learned”, values. In embodiments, a regression neural network may be selected which lacks an activation function, wherein input data may be normalized by mean centering, to determine loss and quantify the accuracy of outputs. Such normalization may use a mean squared error loss function and mean absolute error. The artificial neural network model may be validated and cross-validated using standard techniques such as hold-out, K-fold, etc. In embodiments, multiple artificial neural networks may be separately trained and operated, and/or separately trained and operated in conjunction.

In embodiments, the one or more NLP models 109a3 may include an artificial neural network having an input layer, one or more hidden layers, and an output layer. Each of the layers in the artificial neural network may include an arbitrary number of neurons. The plurality of layers may chain neurons together linearly and may pass output from one neuron to the next, or may be networked together such that the neurons communicate input and output in a non-linear way. In general, it should be understood that many configurations and/or connections of artificial neural networks are possible. For example, the input layer may correspond to input parameters that are given as full sentences, or that are separated according to word or character (e.g., fixed width) limits. The input layer may correspond to a large number of input parameters (e.g., one million inputs), in some embodiments, and may be analyzed serially or in parallel. Further, various neurons and/or neuron connections within the artificial neural network may be initialized with any number of weights and/or other training parameters. Each of the neurons in the hidden layers may analyze one or more of the input parameters from the input layer, and/or one or more outputs from a previous one or more of the hidden layers, to generate a decision or other output. The output layer may include one or more outputs, each indicating a prediction. In some embodiments and/or scenarios, the output layer includes only a single output.

It is noted that although FIG. 1 illustrates the navigation application 108 as a standalone application, the functionality of the navigation application 108 also can be provided in the form of an online service accessible via a web browser executing on the user computing device 102, as a plug-in or extension for another software application executing on the user computing device 102, etc. The navigation application 108 generally can be provided in different versions for different operating systems. For example, the maker of the user computing device 102 can provide a Software Development Kit (SDK) including the navigation application 108 for the Android™ platform, another SDK for the iOS™ platform, etc.

The memory 106 may also store an operating system (OS) 110, which can be any type of suitable mobile or general-purpose operating system. The user computing device 102 may further include a global positioning system (GPS) 112 or another suitable positioning module, a network module 114, a user interface 116 for displaying map data and directions, and input/output (I/O) module 118. The network module 114 may include one or more communication interfaces such as hardware, software, and/or firmware of an interface for enabling communications via a cellular network, a Wi-Fi network, or any other suitable network such as a network 144, discussed below. The I/O module 118 may include I/O devices capable of receiving inputs from, and providing outputs to, the ambient environment and/or a user. The I/O module 118 may include a touch screen, display, keyboard, mouse, buttons, keys, microphone, speaker, etc. In various implementations, the user computing device 102 can include fewer components than illustrated in FIG. 1 or, conversely, additional components.

The user computing device 102 may communicate with a server device 120 and/or a vehicle computing device 150 via a network 144. The network 144 may include one or more of an Ethernet-based network, a private network, a cellular network, a local area network (LAN), and/or a wide area network (WAN), such as the Internet. The navigation application 108 may transmit map data, navigation directions, and other geo-located content from a map database 156 to the vehicle computing device 150 for display on the cluster display unit 151. Additionally, or alternatively, the navigation application 108 may access map, navigation, and geo-located content that is stored locally at the user computing device 102, and may access the map database 156 periodically to update the local data or during navigation to access real-time information, such as real-time traffic data. Moreover, the user computing device 102 may be directly connected to the vehicle computing device 150 through any suitable direct communication link 140, such as a wired connection (e.g., a USB connection).

In certain aspects, the network 144 may include any communication link suitable for short-range communications and may conform to a communication protocol such as, for example, Bluetooth™ (e.g., BLE), Wi-Fi (e.g., Wi-Fi Direct), NFC, ultrasonic signals, etc. Additionally, or alternatively, the network 144 may be, for example, Wi-Fi, a cellular communication link (e.g., conforming to 3G, 4G, or 5G standards), etc. In some scenarios, the network 144 may also include a wired connection.

The server device 120 may be a remotely located server that includes processing capabilities and executable instructions necessary to perform some/all of the actions described herein with respect to the user computing device 102. For example, the server device 120 may include a language processing module 120a that is similar to the language processing module 109a included as part of the user computing device 102, and the module 120a may include one or more of the ASR engine 109a1, the TTS engine 109a2, and/or the NLP model 109a3. Additionally, the server device 120 may include a goal-oriented route generation engine 120b which obtains a set of goals for a user to accomplish, selects a POI for accomplishing each goal, identifies an order for the user to navigate to each POI, and generates a route for navigating to each of the selected POIs in the identified order. The server device 120 may also include an ML module 120c that is similar to the ML module 109b included as part of the user computing device 102.

The vehicle computing device 150 includes one or more processor(s) 152 and a memory 153 storing computer-readable instructions executable by the processor(s) 152. The memory 153 may store a language processing module 153a, a navigation application 153b, and a ML module 153c that are similar to the language processing module 153a, the navigation application 108, and the ML module 109b, respectively. The navigation application 153b may support similar functionalities as the navigation application 108 from the vehicle-side and may facilitate rendering of information displays, as described herein. For example, in certain aspects, the user computing device 102 may provide the vehicle computing device 150 with an accepted route that has been accepted by a user, and the corresponding navigation instructions to be provided to the user as part of the accepted route. The navigation application 153b may then proceed to render the navigation instructions within the cluster unit display 151 and/or to generate audio outputs that verbally provide the user with the navigation instructions via the language processing module 153a.

In any event, the user computing device 102 may be communicatively coupled to various databases, such as a map database 156, a traffic database 157, and a POI database 159, from which the user computing device 102 can retrieve navigation-related data. The map database 156 may include map data such as map tiles, visual maps, road geometry data, road type data, speed limit data, etc. The map database 156 may also include route data for providing navigation directions, such as driving, walking, biking, or public transit directions, for example. The traffic database 157 may store historical traffic information as well as real-time traffic information. The POI database 159 may store descriptions, locations, images, and other information regarding landmarks, places, or other points-of-interest, such as restaurants, bars, hotels, movie theatres, amusement parks, stadiums, concert venues, opera houses, casinos, museums, parks, bowling alleys, pool halls, pharmacies, grocery stores, banks, department stores, hardware stores, convenience stores, supermarkets, farmer's markets, gyms, swimming pools, tennis courts, waterparks, zoos, aquariums, etc. For example, POI database 159 may store metadata associated with each POI. The particular metadata stored depends on the POI. For example, a grocery store may include product or stock metadata that includes a list of all products stocked at that grocery store. As another example, a restaurant may include food type metadata indicating the type(s) of food, or even the specific meals, served at that restaurant. POI metadata may also include the location of the POI. Where relevant, POI metadata may also include opening times, ticket prices, reservation availability or any other data useful for distinguishing POIs of similar types from one another. For example, grocery store A may have metadata specifying that one product stocked is gluten free bread, whereas grocery store B may not have such metadata, thus indicating that gluten free bread can be purchased from grocery store A but not from grocery store B. Where appropriate, various POIs may include stock data as metadata which may be updated from and/or synchronized with stock data held at a server of the POI such that the stock data is maintained up-to-date in POI database 159.

While FIG. 1 depicts databases 156, 157, and 159, the user computing device 102, the vehicle computing device 150, and/or the server device 120 may be communicatively coupled to additional, or conversely, fewer, databases. For example, the user computing device 102 and/or the vehicle computing device 150 may be communicatively coupled to a database storing weather data.

When the user provides a text or audio request for navigation directions for accomplishing a particular set of goals via the navigation application 108, the user computing device 102 may provide the request to the server device 120. The user may provide a particular trigger phrase or hot word which causes the navigation application 108 to receive the audio request from the user, such as “Hey Maps.” The user may also provide a particular mode of transportation for the navigation directions, such as driving directions, walking directions, biking directions, public transportation directions, ridesharing directions, etc.

Additionally, the language processing module 109a, 120a at the user computing device 102 or the server device 120 may analyze the request to determine 1) the intent to use goal-based input, and/or 2) the list of goals included in the request. For example, the language processing module 109a, 120a may determine that the request includes goal-based input if the request includes products, items, meals, activities, etc. The language processing module 109a, 120a may also utilize the machine learning module 109b, 120c to determine whether a request includes goal-based input. For example, the machine learning module 109b, 120c may generate a machine learning model 109b1 trained using a first set of navigation requests which are not goal-based and a second set of navigation requests which are goal-based. The machine learning model 109b1 can include one or more tests for distinguishing whether a request is goal-based or not based on the training data. The language processing module 109a, 120a may apply the request to the machine learning model 109b1 to determine whether the request includes goal-based input.

To identify the list of goals included in the request, the language processing module 109a, 120a may separate out each product or item the user wants to purchase, and/or each activity that the user wants to perform. In some scenarios, the goal-based request may refer to an external resource, such as “My Shopping List.” The language processing module 109a, 120a may access a user account for the user such as user profile stored at the server device 120 to retrieve the external resource and identify the items in the user's shopping list. In other implementations, the external resource may be stored at the user computing device 102, such as in a notes application or another third-party application executing on the user computing device 102. The language processing module 109a, 120a may communicate with the third-party application by invoking an application programming interface (API) to obtain the external resource.

In any event, the server device 120 obtains the intent to use goal-based input and/or the list of goals included in the request from the user computing device 102, or obtains the request from the user computing device 102 and determines the intent and/or list of goals from the request. Then the server device 120, and more specifically, the goal-oriented route generation engine 120b identifies a POI for accomplishing each goal in the list of goals by, for example, communicating with the POI database 159.

For each goal, the goal-oriented route generation engine 120b identifies a set of candidate POIs from the POI database 159 where the goal can be accomplished. In some implementations, the goal-oriented route generation engine 120b obtains a current location of the user or another starting location and identifies candidate POIs which are within a threshold radius of the user's current or starting location.

Also in some implementations, a particular goal may have a predetermined POI. For example, the server device 120 may store a user profile for the user which includes designated locations, such as “my gym,” “my grocery store,” “my home,” etc. If the user wants to work out or purchase groceries, the goal-oriented route generation engine 120b may infer that these respective goals will be accomplished at the POI corresponding to “my gym” and “my grocery store.”

In any event, when the list of goals includes N goals, the goal-oriented route generation engine 120b may identify N sets of candidate POIs for accomplishing the N goals. In some instances, a set of candidate POIs may only include one candidate POI, such as when a particular goal has a predetermined POI (e.g., the user wants to work out and has a gym marked as “my gym”). The goal-oriented route generation engine 120b may then select one POI from each of the N sets of candidate POIs which minimizes the total number of selected POIs and/or which minimizes the distance or duration from the user's current location to the selected POIs. For example, the goal-oriented route generation engine 120b may determine the distance or duration between each of the POIs in the N sets of candidate POIs and/or between each POI and the user's current location. When multiple sets include the same POI, the goal-oriented route generation engine 120 may determine that the distance or duration for the same POI is zero.

Then the goal-oriented route generation engine 120b may iterate over each combination of POIs which includes one member of each of the N sets of candidate POIs to identify the combination having the minimum distance or duration. The goal-oriented route generation engine 120b may select the same POI for accomplishing multiple goals if the same POI is included in multiple sets of candidate POIs. In this manner, the goal-oriented route generation engine 120b may select M POIs for accomplishing N goals, where M<N.

More specifically, the goal-oriented route generation engine 120b may identify each combination of POIs which includes one member of each of the N sets of candidate POIs. When a particular combination includes multiple instances of the same POI, the goal-oriented route generation engine 120b may remove the duplicate, such that the combination includes fewer than N POIs.

Then the goal-oriented route generation engine 120b may provide a particular combination of POIs to the map database 156 for example, for the map database 156 to generate a route from the user's current location to the particular combination of POIs and/or estimate a duration or distance for the route. The goal-oriented route generation engine 120b may provide the particular combination of POIs in a particular order, for example when the user specifies the order in which they want to accomplish the goals. In other implementations, the goal-oriented route generation engine 120 may not specify the order for traveling to the POIs.

Instead, the goal-oriented route generation engine 120b may iterate over every possible order to identify the ordered combination of M POIs which minimizes the duration or distance for accomplishing the set of N goals. In some implementations, the goal-oriented route generation engine 120b may provide each ordered combination of POIs which includes one member of each of the N sets of candidate POIs to the map database 156 to select M POIs which minimizes the duration or distance for accomplishing the set of N goals, and/or select the order for traveling to the M POIs.

In some implementations, the goal-oriented route generation engine 120b may rank combinations of M POIs for accomplishing the set of N goals according to the duration or distance for traveling to the combinations of M POIs. In other implementations, the goal-oriented route generation engine 120b may rank combinations of M POIs for accomplishing the set of N goals according to other characteristics or preferences such as store hours, a preferred order by the user, etc. The goal-oriented route generation engine 120b may select the highest ranking combination (e.g., the combination which minimizes the duration or distance for accomplishing the set of N goals) or may provide multiple combinations of M POIs to the user computing device 102 for the user to choose from. The user may then select one of the multi-destination route options.

Additionally or alternatively, the goal-oriented route generation engine 120b may determine or adjust the order for traveling to the M POIs based on store hours for each of the M POIs. The goal-oriented route generation engine 120b may obtain the store hours for each of the M POIs from the POI database 159. The goal-oriented route generation engine 120b may also estimate the amount of time for each visit to the M POIs. For example, the amount of time for a particular visit to a POI may be proportional to the number of goals to accomplish at the POI. Additionally, some activities such as working out or eating a meal may take longer than others such as purchasing an item. The goal-oriented route generation engine 120b may also estimate the amount of time for a particular visit based on the type of goal being accomplished during the visit.

In any event, the goal-oriented route generation engine 120b may estimate the time when the user will arrive at each of the M POIs based on the start time when the user provided the goal-based input, the estimated duration for traveling to each POI, and/or the amount of time for each visit to the M POIs. If the estimated time of arrival at a particular POI is before the store opens or after the store closes, the goal-oriented route generation engine 120b may adjust the order for traveling to the M POIs so that the user arrives at each of the M POIs during store hours. Otherwise, the goal-oriented route generation engine 120b may replace one of the M POIs with another candidate POI which is open at the time the user is likely to arrive at the POI.

Then the goal-oriented route generation engine 120b obtains a set of navigation directions for traveling along a route to the M POIs in the selected order from the map database 156. The goal-oriented route generation engine 120b may then provide the set of navigation directions to the user computing device 102. The goal-oriented navigation display 160 may then present an indication of the route and/or the set of navigation directions on the user interface 116 of the user computing device. In some implementations, the goal-oriented navigation display 160 may present indications of each of the selected POIs on a map display of the navigation application. The goal-oriented navigation display 160 may also annotate each selected POI on the map display with a description of the corresponding goal(s) to accomplish at the selected POI.

In other implementations, the goal-oriented navigation display 160 may present the set of navigation directions as a set of audio navigation instructions via the speakers 118 of the user computing device 102. The goal-oriented navigation display 160 may also present audio announcing the selected POIs for accomplishing the set of goals, and/or indicating the goal(s) to be accomplished at each POI. For example, the goal-oriented navigation display 160 may provide the audio announcement before providing the set of audio navigation instructions to the user.

Additionally or alternatively, when the user arrives at one of the selected POIs, the goal-oriented navigation display 160 may present an indication on the map display of the goal(s) to accomplish at the POI, and/or may present an audio announcement to the user indicating the goal(s) to accomplish at the POI.

### Example Requests for Goal-Oriented Navigation Instructions

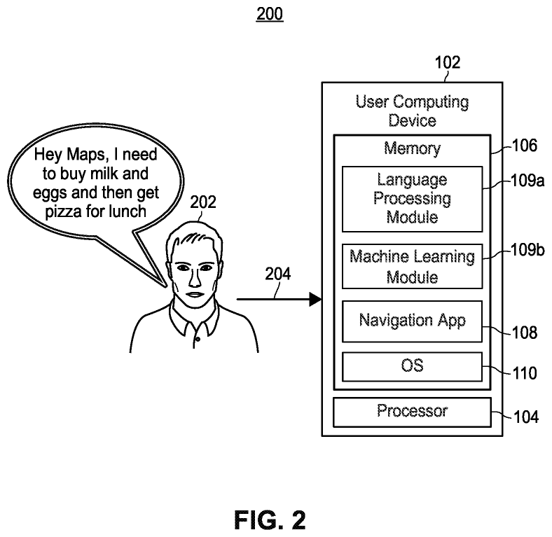

The techniques of this disclosure for goal-oriented navigation are discussed below with reference to the conversation flows and map displays illustrated in FIGS. 2-5. Throughout the description of FIGS. 2-5, actions described as being performed by the user computing device 102 may, in some implementations, be performed by the server device 120, the vehicle computing device 150, and/or may be performed by the user computing device 102, the server device 120, and/or the vehicle computing device 150 in parallel. For example, the user computing device 102, the server device 120, and/or the vehicle computing device 150 may utilize the language processing module 109a, 120a, 153a and/or the machine learning module 109b, 120c, 153c to identify a set of goals included in the user's request and provide navigation directions and responses to the request.

While the example scenarios in FIGS. 2-5 include requests related to driving directions these are merely a few examples for ease of illustration only. The goal-oriented navigation system can be used for any suitable mode of transportation including driving, walking, biking, or public transportation.

Additionally, while the example scenarios described herein are generally in the context of a speech based configuration, the goal-oriented navigation system can also be used in the context of a touch-based or visual interface. For example, user requests for navigation information can be entered via free-form textual input or through UI elements (e.g. a drop-down menu). Responses to the user requests can be displayed to the user via the user interface. Embodiments disclosed herein that are described in the context of a speech-based interface may also be applied to the context of a touch-based interface. All embodiments disclosed herein in which inputs or outputs are described in the context of a speech-based interface may be adapted to apply to the context of a touch-based interface.

FIG. 2 illustrates an example scenario 200 where the user 202 provides goal-based input to the user computing device 102. More specifically, the user 202 states 204, “Hey Maps, I need to buy milk and eggs and then get pizza for lunch.” While this example specifies the procurement of particular goods (milk, eggs, pizza), other goals may be availing or making use of a particular service such as going to the dentist, getting a haircut, or going to the gym.

The language processing module 109a, 120a at the user computing device 102 and/or the server device 120 may then analyze the user's request to determine the intent is to use goal-based input and the list of goals includes purchasing milk, purchasing eggs, and having lunch at a restaurant that serves pizza.

For each goal, the server device 120 obtains a set of candidate POIs from the POI database 159 where the goal can be accomplished. Specifically, in this example each candidate POI is a POI in which the user is able to one or more of (a) purchase milk, (b) purchase eggs, and (c) get pizza for lunch, each of (a), (b) and (c) being a goal to accomplish. Such POIs may be determined based on an analysis of corresponding POI metadata in the POI database 159 which specifies which POIs stock milk and/or eggs, and which POIs serve pizza and optionally have opening times corresponding to lunch time. In some implementations, the server device 120 identifies candidate POIs which are within a threshold radius of the user's current location and/or within the same geographic area as the user's current location (e.g., the same city, state, country, etc.). Then the server device 120 communicates with the map database 156 to identify a combination of POIs including one member of each set of candidate POIs that minimizes the distance or duration from the user's current location to each of the POIs in the combination. The server device 120 may also identify an order for the combination to further minimize the distance or duration. Additionally, the server device 120 may identify the same POI for accomplishing multiple goals to minimize the total number of POIs selected.

In the example scenario 200, the server device 120 identifies the same POI (Bob's Market) for purchasing both the milk and the eggs and a second POI (John's Pizza) for having lunch. The server device 120 may also determine that the user should travel to Bob's Market first and then John's Pizza. The server device 120 obtains a set of navigation directions for traveling along a route to Bob's Market and then John's Pizza from the map database 156 and provides the set of navigation directions to the user computing device 102. The server device 120 may also provide information to the user computing device 102 indicating which goals correspond to which POIs.

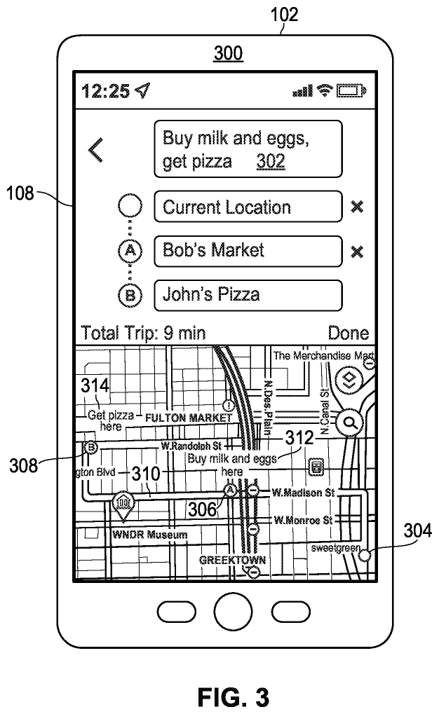

Then the user computing device 102 may present a map display indicating the POIs, the route, and/or the goals to accomplish at each goal. FIG. 3 illustrates an example map display 300 which may be presented, via the navigation application 108, on the user interface 116 of the user computing device 102.

The map display 300 includes a condensed version of the user's goal-based input 302, an indication of the user's current location 304, and an indication of each of the POIs 306, 308 for completing the user's goals. Additionally, the map display 300 includes an indication of a route 310 for traveling to the POIs 306, 308. Still further, the map display 300 is annotated with descriptions 312, 314 of the corresponding goal(s) to accomplish at each POI 306, 308. More specifically, for Bob's Market 306, the map display 300 is annotated with an instruction to “Buy milk and eggs here” 312. For John's Pizza, the map display 300 is annotated with an instruction to “Get pizza here” 314. In this manner, the user is given instructions for where to accomplish each goal, and the user can verify that each of the goals will be accomplished at the selected POIs. Beneficially, by providing instructions for where to accomplish each goal, the user is informed of the most efficient way of completing all the goals. For example, at a different time it may be the case that Bob's Market 306 only stocks milk but not eggs, however the user may assume that Bob's Market 306 stocks both based on prior knowledge and/or the POI type. Thus, by informing the user that only milk is to be purchased at Bob's Market 306, the user is notified to only seek milk in this location and therefore await another POI along the route to purchase eggs.

In some implementations, the user computing device 102 may also present a set of audio navigation instructions via the speakers 118 for navigating to the selected POIs 306, 308. The user computing device 102 may present audio announcing the selected POIs 306, 308 for accomplishing the set of goals, and/or indicating the goal(s) to be accomplished at each POI. For example, the user computing device 102 may provide the audio announcement before providing the set of audio navigation instructions to the user.

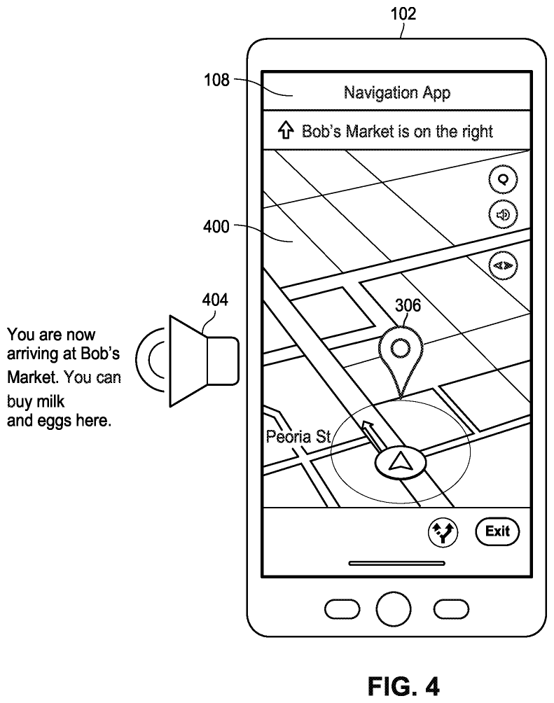

Additionally or alternatively, when the user arrives at one of the selected POIs 306, 308, the user computing device 102 may present an indication on the map display of the goal(s) to accomplish at the POI 306, and/or may present an audio announcement to the user indicating the goal(s) to accomplish at the POI 306. FIG. 4 illustrates an example map display 400 which may be presented as the user approaches Bob's Market 306. As the user approaches Bob's Market 306, the user computing device 102 presents an audio announcement 404 via the speakers 118. For example, the audio announcement may be, “You are now arriving at Bob's Market. You can buy milk and eggs here” 404. In this manner, the user is reminded of the goals to accomplish at the POI 306.

The user computing device 102 may generate the text of the audio announcement 404 by utilizing the language processing module 109a, and in certain aspects, a large language model (LLM) (e.g., language model for dialogue applications (LaMDA)) (not shown) included as part of the language processing module 109a. Such an LLM may be conditioned/trained to generate the audio announcement text based on the particular most common attributes of the POI 306 and corresponding goals, and/or the LLM may be trained to receive a natural language representation of the POI 306 and corresponding goals as input and to output a set of text representing the audio announcement 404 based on the most common attributes.

In any event, when the user computing device 102 fully generates the text of the audio announcement 404, the user computing device 102 may proceed to synthesize the text into speech for audio output to the user. In particular, the user computing device 102 may transmit the text of the audio announcement 404 to a TTS engine (e.g., TTS engine 109a2) in order to audibly output the audio announcement 404 through a speaker 118, so that the user may hear and interpret the audio announcement. Additionally, or alternatively, the user computing device 102 may also visually prompt the user by displaying the text of the audio announcement 404 on the map display 400.

In some scenarios, the user may have a list of items for purchasing, and/or activities to participate in, and/or services of which to make use. The list may be stored in a third-party application executing on the user computing device 102, such as a notes application. In other scenarios, the list may be stored at the server device 120, such as a document stored in cloud storage in association with a user profile for the user. The language processing module 109a, 120a may obtain the list from cloud storage, by invoking an API of the third-party application, or by communicating with any suitable server or database where the list is stored via the network 144.

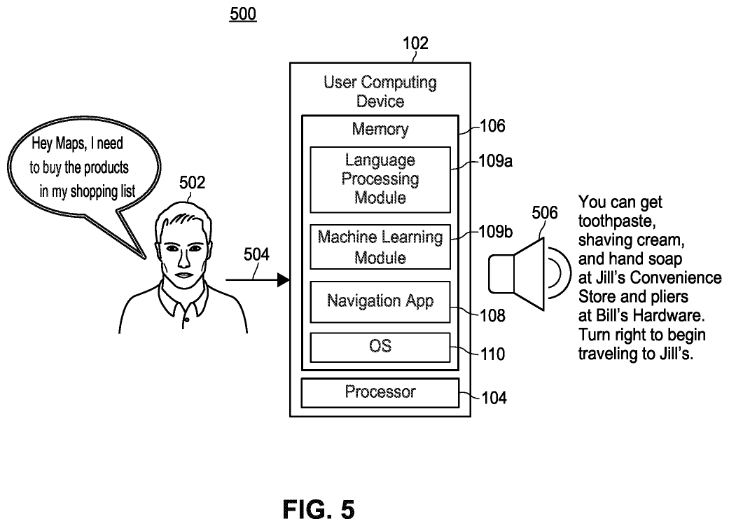

FIG. 5 illustrates an example scenario 500 where the user 202 provides goal-based input to the user computing device 102 for purchasing a list of items from an external resource. More specifically, the user 502 states 504, “Hey Maps, I need to buy the products in my shopping list.”

The language processing module 109a, 120a at the user computing device 102 and/or the server device 120 may then analyze the user's request to determine the intent is to use goal-based input and the list of goals can be found by accessing a shopping list associated with the user. The language processing module 109a, 120a may then obtain a document stored at the server device 120 as “My Shopping List” in the user profile. Then the language processing module 109a, 120a identifies each of the items, products, or activities in the list as separate goals. The items or products can include groceries, other food items, cleaning products, household products, clothing, hardware, etc. The activities may include picking up dry cleaning, dropping off a jacket to be repaired, etc.

For each goal, the server device 120 obtains a set of candidate POIs from the POI database 159 where the goal can be accomplished. Then the server device 120 communicates with the map database 156 to identify a combination of POIs that includes one member of each set of candidate POIs and minimizes the distance or duration from the user's current location to each of the POIs in the combination. The server device 120 may also identify an order for the combination to further minimize the distance or duration. Additionally, the server device 120 may identify the same POI for accomplishing multiple goals to minimize the total number of POIs selected.

In the example scenario 500, the server device 120 identifies the same POI (Jill's Convenience Store) for purchasing toothpaste, shaving cream, and hand soap, and a second POI (Bill's Hardware) for purchasing pliers. The server device 120 may also determine that the user should travel to Jill's Convenience Store first and then Bill's Hardware. The server device 120 obtains a set of navigation directions for traveling along a route to Jill's Convenience Store and then Bill's Hardware from the map database 156 and provides the set of navigation directions to the user computing device 102. The server device 120 may also provide information to the user computing device 102 indicating which goals correspond to which POIs.

Then the user computing device 102 may present a set of audio navigation instructions via the speakers 118 for navigating to the selected POIs. The user computing device 102 may present audio 506 announcing the selected POIs for accomplishing the set of goals, and/or indicating the goal(s) to be accomplished at each POI. For example, the user computing device 102 may provide the audio announcement 506 before providing the set of audio navigation instructions to the user. More specifically, the user computing device 102 may provide the following audio announcement: “You can get toothpaste, shaving cream, and hand soap at Jill's Convenience Store and pliers at Bill's Hardware. Turn right to begin traveling to Jill's” 506. Then the user may turn right and the user computing device 102 may provide the set of audio navigation instructions to the user for navigating along a route to Jill's Convenience Store and Bill's Hardware.

When the user leaves a particular POI, the user may provide input to the user computing device 102 indicating which of the goals were accomplished at the POI. In some scenarios, the user may not have been able to purchase a particular product at the POI or perform a particular activity. The user may indicate that the particular POI was closed or the POI did not have the particular product in stock.

Accordingly, the goal-oriented route generation engine 120b may identify a backup POI from a set of backup POIs for accomplishing the particular goal, for example based on proximity to the user's current location or to other POIs on the user's route. For example, when the goal-oriented route generation engine 120b selects the combination of M POIs from the N sets of candidate POIs, the goal-oriented route generation engine 120b may store the remaining candidate POIs which were not selected as backup POIs. Then the goal-oriented route generation engine 120b may communicate with the map database 156 to adjust the set of navigation directions to include the backup POI.

The goal-oriented route generation engine 120b may store the backup POIs for accomplishing a particular goal in a ranked order according to their duration or distance from the selected POI for accomplishing the particular goal and/or according to their duration or distance from the next selected POI on the route. For example, when the user indicates that the user was unable to accomplish the particular goal at the selected POI, the goal-oriented route generation engine 120b identifies the highest ranking backup POI for accomplishing the particular goal and adjusts the set of navigation directions to include the highest ranking backup POI. If the user is unable to accomplish the goal at the highest ranking backup POI, the goal-oriented route generation engine 120b may re-rank the backup POIs based on duration or distance to the highest ranking backup POI and/or to the next selected POI on the route, and select the next highest ranking backup POI. The goal-oriented route generation engine 120b may continue to repeat this process until the user is able to accomplish the particular goal.

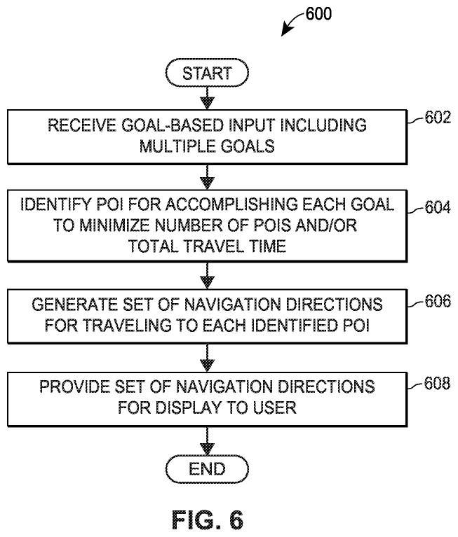

FIG. 6 is a flow diagram of an example method 600 for providing navigation directions to one or more POIs for accomplishing a user's goals, which can be implemented in the server device 120. More specifically, the method 600 can be implemented in a set of instructions stored on a computer-readable memory and executable at one or more processors of the server device 120.

It is to be understood that, throughout the description of FIG. 6, actions described as being performed by the server device 120 may, in some implementations, be performed by the user computing device 102, the vehicle computing device 150, and/or may be performed by the user computing device 102, the server device 120, and/or the vehicle computing device 150 in parallel. For example, the user computing device 102, the server device 120, and/or the vehicle computing device 150 may utilize the language processing module 109a, 120a, 153a and/or the machine learning module 109b, 120c, 153c to identify goal-based input and provide announcements and navigation directions to POIs for accomplishing the user's goals.

At block 602, the server device 120 receives goal-based input (e.g., text or audio input) from the user computing device 102 including a set of N goals where N is greater than one. The server device 102 identifies each of N goals included in the goal-based input and identifies N sets of candidate POIs for accomplishing the N goals. In some instances, a set of candidate POIs may only include one candidate POI, such as when a particular goal has a predetermined POI (e.g., the user wants to work out and has a gym marked as “my gym”).

The server device 120 may then select one POI from each of the N sets of candidate POIs which minimizes the total number of selected POIs and/or which minimizes the distance or duration from the user's current location to the selected POIs (block 604). For example, the server device 120 may determine the distance or duration between each of the POIs in the N sets of candidate POIs and/or between each POI and the user's current location. When multiple sets include the same POI, the server device 120 may determine that the distance or duration for the same POI is zero.

Then the server device 120 may iterate over each combination of POIs which includes one member of each of the N sets of candidate POIs to identify the combination having the minimum distance or duration. The server device 120 may select the same POI for accomplishing multiple goals if the same POI is included in multiple sets of candidate POIs. In this manner, the server device 120 may select M POIs for accomplishing N goals, where M<N.

At block 606, the server device 120 generates a set of navigation directions for traveling to the selected POIs. For example, the server device 120 may provide the selected POIs to the map database 156 for example, for the map database 156 to generate a route from the user's current location to the selected POIs and/or estimate a duration or distance for the route.

Then at block 608, the server device 120 provides the set of navigation directions to the user computing device 102 for display to the user. The user computing device 102 may then present an indication of the route and/or the set of navigation directions on the user interface 116. In some implementations, the user computing device 102 may present indications of each of the selected POIs on a map display of the navigation application. The user computing device 102 may also annotate each selected POI on the map display with a description of the corresponding goal(s) to accomplish at the selected POI.

In other implementations, the user computing device 102 may present the set of navigation directions as a set of audio navigation instructions via the speakers 118. The user computing device 102 may also present audio announcing the selected POIs for accomplishing the set of goals, and/or indicating the goal(s) to be accomplished at each POI.

Additionally or alternatively, when the user arrives at one of the selected POIs, the user computing device 102 may present an indication on the map display of the goal(s) to accomplish at the POI, and/or may present an audio announcement to the user indicating the goal(s) to accomplish at the POI.

### ADDITIONAL CONSIDERATIONS

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The method 600 may include one or more function blocks, modules, individual functions or routines in the form of tangible computer-executable instructions that are stored in a computer-readable storage medium, optionally a non-transitory computer-readable storage medium, and executed using a processor of a computing device (e.g., a server device, a personal computer, a smart phone, a tablet computer, a smart watch, a mobile computing device, or other client computing device, as described herein). The method 600 may be included as part of any backend server (e.g., a map data server, a server device, or any other type of server computing device, as described herein), client computing device modules of the example environment, for example, or as part of a module that is external to such an environment. Though the figures may be described with reference to the other figures for ease of explanation, the method 600 can be utilized with other objects and user interfaces. Furthermore, although the explanation above describes steps of the method 600 being performed by specific devices (such as a server device), this is done for illustration purposes only. The blocks of the method 600 may be performed by one or more devices or other parts of the environment.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for providing navigation directions to one or more POIs for accomplishing a user's goals through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for providing navigation directions to one or more points of interest (POIs) for accomplishing a user's goals, the method comprising:
receiving, at the one or more processors, an indication of N goals for a user to accomplish;
identifying, by the one or more processors, M POIs for accomplishing the N goals, wherein Nis greater than M;
generating, by the one or more processors, a set of navigation directions for navigating to each of the M POIs; and
providing, by the one or more processors, the set of navigation directions for display to the user.

2. The method of claim 1, wherein the N goals include at least one of:
purchasing one or more products;
making use of one or more services; or
participating in one or more activities.

3. The method of claim 1, wherein generating the set of navigation directions includes:
generating, by the one or more processors, the set of navigation directions for navigating to each of the M POIs along a route that minimizes a distance or duration to each of the M POIs.

4. The method of claim 3, further comprising:
selecting, by the one or more processors, an order for navigating to each of the M POIs to minimize the duration or distance of the route.

5. The method of claim 1, wherein identifying the M POIs includes:
identifying, by the one or more processors, candidate POIs that correspond to each of the N goals; and
selecting, by the one or more processors, one or more of the candidate POIs based on at least one of: (i) a distance from a current location of the user, or (ii) a distance from each other.

6. The method of claim 1, further comprising:
providing, by the one or more processors, one or more instructions for display to the user indicating at least one of the N goals to accomplish at each of the M POIs.

7. The method of claim 1, further comprising:
identifying, by the one or more processors, one or more backup POIs for the user to navigate to in response to determining that at least one of the N goals cannot be accomplished at the M POIs;
in response to determining that the at least one goal cannot be accomplished at the M POIs, selecting, by the one or more processors, at least one of the one or more backup POIs for accomplishing the at least one goal; and
adjusting, by the one or more processors, the set of navigation directions to include the selected backup POI.

8. The method of claim 1, further comprising:
selecting, by the one or more processors, an order for navigating to each of the M POIs based on store hours of each of the M POIs.

9. A computing device for providing navigation directions to one or more points of interest (POIs) for accomplishing a user's goals, the computing device comprising:
one or more processors; and
a computer-readable memory coupled to the one or more processors and storing instructions thereon that, when executed by the one or more processors, cause the computing device to:
receive an indication of N goals for a user to accomplish;
identify M POIs for accomplishing the N goals, wherein N is greater than M;
generate a set of navigation directions for navigating to each of the M POIs; and
provide the set of navigation directions for display to the user.

10. The computing device of claim 9, wherein the N goals include at least one of:
purchasing one or more products;
making use of one or more services; and
participating in one or more activities.

11. The computing device of claim 9, wherein the set of navigation directions are generated for navigating to each of the M POIs along a route that minimizes a distance or duration to each of the M POIs.

12. The computing device of claim 11, wherein the instructions further cause the computing device to:
select an order for navigating to each of the M POIs to minimize the duration or distance of the route.

13. The computing device of claim 9, wherein to identify the M POIs, the instructions cause the computing device to:
identify candidate POIs that correspond to each of the N goals; and
select one or more of the candidate POIs based on at least one of: (i) a distance from a current location of the user, or (ii) a distance from each other.

14. The computing device of claim 9, wherein the instructions further cause the computing device to:
provide one or more instructions for display to the user indicating at least one of the N goals to accomplish at each of the M POIs.

15. The computing device of claim 9, wherein the instructions further cause the computing device to:
identify one or more backup POIs for the user to navigate to in response to determining that at least one of the N goals cannot be accomplished at the M POIs;
in response to determining that the at least one goal cannot be accomplished at the M POIs, select at least one of the one or more backup POIs for accomplishing the at least one goal; and
adjust the set of navigation directions to include the selected backup POI.

16. The computing device of claim 9, wherein the instructions further cause the computing device to:
select an order for navigating to each of the M POIs based on store hours of each of the M POIs.

17. A computer-readable medium storing instructions thereon, that when executed by one or more processors cause the one or more processors to:
receive an indication of N goals for a user to accomplish;
identify M POIs for accomplishing the N goals, wherein Nis greater than M;
generate a set of navigation directions for navigating to each of the M POIs; and
provide the set of navigation directions for display to the user.

18. The computer-readable medium of claim 17, wherein the N goals include at least one of:
purchasing one or more products;
making use of one or more services; and
participating in one or more activities.

19. The computer-readable medium of claim 17, wherein the set of navigation directions are generated for navigating to each of the M POIs along a route that minimizes a distance or duration to each of the M POIs.

20. The computer-readable medium of claim 19, wherein the instructions further cause the one or more processors to:
select an order for navigating to each of the M POIs to minimize the duration or distance of the route.
